(19) United States
(12) Patent Application Publication
(10) Pub. No.: US 2004/0186823 A1
(43) Pub. Date: Sep. 23, 2004

(54) Data packet processing

(75) Inventor: Gero Dittman, Zurich (CH)

Correspondence Address: LOUIS P. HERZBERG, Intellectual Property Law Dept., IBM Corporation, P.O. Box 218, Yorktown Heights, NY, 10598, US

(73) Assignee: International Business Machines Corporation, Armonk, NY (US)

(21) Appl. No.: 10/776,788

(22) Filed: Feb. 11, 2004

(30) Foreign Application Priority Data
Feb. 12, 2003 (CH) EP 03405079

(51) Int. Cl. G06F 7/00

(52) U.S. Cl. 707/1

(57) ABSTRACT

This invention provides a data packet processing device for processing data packets received from a network, including: a processing means for processing data packets; an interface operable to transmit data packets to and from an external memory; a scheduling means for assigning priority information to received data packets, wherein the priority information determines an order of data packets to be processed; an internal memory to store data packets; a memory managing means operable to store data packets in the external memory and to provide data packets in the internal memory for processing in the processing means, wherein depending on the priority information of each of the data packets, the memory managing means provides the respective data packets assigned by the respective priority information in the internal memory for being processed by the processing means.

### FIELD OF INVENTION

The present invention is directed to a data packet processing device for processing data packets and a method thereto.

### BACKGROUND

One of the major challenges in processor design is the optimization of the access latency to external memories. Access latency is the time used by the processor to transmit data via an interface to the external memory or receive data from the external memory via the interface. Furthermore, external memories often comprise DRAM memories which usually are slow memory devices having a long access latency.

To speed up the access time for data packets, an internal on-chip memory is usually provided to buffer parts of the content of the slower external memory. This process is called “caching” and the internal on-chip memory is called a “cache”.

The cache replacement strategies commonly used in general purpose processors (GPP) are not appropriate for network processors (NP) as the data access patterns of NP applications differ significantly from GPP applications. In general purpose processors the cache is provided with data from addresses following the address actually being processed.

The data access patterns for network processors differs therefrom as the data packet are received from a network continuously and the execution priority is determined after reception of a data packet. Thus the memory addresses of the data packets to be cached are independent from one another. Furthermore the memory access has to be very flexible as the data packet to be accessed next can change with every newly received data packet.

The principle of speeding up data access by means of a memory hierarchy has been integral to computers for a long time. All major general purpose processors today use on-chip caches. Possible cache replacement strategies include FIFO, LRU and random.

In the documents U.S. Pat. No. 5,651,002 and U.S. Pat. No. 5,787,255, methods are described to store packet headers in faster SRAMs while storing the user data parts of packets the in DRAMs. Often, there is no clear distinction between header and user data. Thus, a system that speeds up access to only a small part of the packet is not appropriate to speed up the processing of the whole data packet.

### SUMMARY OF THE INVENTION

Therefore, it is an aspect of the present invention to provide a smart processing strategy for a data packet processing device, especially for a data packet processing device to be located in a network. The above-mentioned aspect is attained by the data packet processing device and method for processing data packets described herein.

According to a first embodiment of the present invention, a data packet processing device for processing data packets received from a network is provided. The data packet processing device includes a processor for processing said data packets. An interface is operated to transmit data packets to and from an external memory. A scheduler assigns priority information to typically each of the received data packets, wherein the priority information determines an order of the data packets to be processed. The data packet processing device further includes an internal memory to store data packets. A memory manager is provided operable to cause storing data packets in the external memory and to provide data packets in the internal memory for processing in the processor. Depending on the priority information of the data packets, the memory manager provides the respective data packets assigned by the respective priority information in the internal memory for being processed by the processor.

The present invention has the advantage that data packets are not preloaded in the internal memory in a manner known from GPP which is not related to the priority of the respective data packet. As it is determined by the scheduler, the order of the processing of the data packets can be used to store the data packets in the internal memory to be processed next.

According to another embodiment of the present invention, a method for processing data packets is provided. The data packets which are received from the network are processed, whereby a priority information is assigned to the received data packets. The priority information determines an order of the data packets to be processed. The received data packets are stored in a fast accessible memory, wherein depending on the priority information of the received data packets, the respective data packets are provided in the fast accessible memory for being processed or transferred from a fast accessible memory to a main memory.

The method according to the present invention provides optimized caching of data packets in a fast accessible memory, e.g. a cache memory or another on-chip memory, which is also called internal memory. While conventional methods of caching data are directed to preload data at addresses following to the actually executed address, the method according to the present invention provides an option to use the priority information determined by the scheduling means not only for determining the order in which the data packets are provided to the processing means but also to determine the data packets that are to be available in the fast accessible memory.

### BRIEF DESCRIPTION OF THE DRAWINGS

The foregoing and other aspects of these teachings are made more evident in the following detailed description of the invention, when read in conjunction with the attached drawing figures, wherein:

FIG. 1 shows a data packet processing device according to an embodiment of the present invention; and

FIGS. 2a and 2b show flow charts of a method for processing data packets according to another embodiment of the present invention.

### DETAILED DESCRIPTION OF THE INVENTION

This invention provides methods, apparatus and systems to provide a smart processing strategy for a data packet processing device, especially for a data packet processing device to be located in a network. The invention includes a data packet processing device and a method for processing data packets described herein.

In an example embodiment of the present invention, a data packet processing device for processing data packets received from a network is provided. The data packet processing device includes a processor for processing said data packets. An interface is operated to transmit data packets to and from an external memory. A scheduler assigns priority information to typically each of the received data packets, wherein the priority information determines an order of the data packets to be processed. The data packet processing device further includes an internal memory to store data packets. A memory manager is provided operable to cause storing data packets in the external memory and to provide data packets in the internal memory for processing in the processor. Depending on the priority information of the data packets, the memory manager provides the respective data packets assigned by the respective priority information in the internal memory for being processed by the processor.

In conventional data packet processing devices, the scheduling means is provided to determine the priority of each of the received data packets to find out which data packet should be processed next by the processing means. Furthermore, in conventional general processing devices, internal memories, e.g. caches are provided to speed up the accessing of data by the processing means. Usually, an internal memory is controlled by its own cache controllers which decides by itself what data should be preloaded and buffered in the internal memory.

The present invention now provides that information about the priority of the received data packets given by the scheduling means can be used by the controller for the internal memory. The internal memory is preloaded with one or more data packets from the external memory depending on the priority information of the respective data packet, or is preloaded with one or more data packets which are to be transferred to the external memory for storage purposes, but now are kept stored in the internal memory due to high priority which means that they are to be processed next.

The present invention has an advantage that data packets are not preloaded in the internal memory in a manner known from GPP which is not related to the priority of the respective data packet. As it is determined by the scheduler, the order of the processing of the data packets can be used to store the data packets in the internal memory to be processed next.

Preferably, the memory manager loads a data packet stored in the external memory into the internal memory depending on the priority information of this data packet. This has the advantage that the data packets having the highest priority of all received data packets are transferred to the internal memory to be processed as one of the next.

The memory manager can also transmit a received data packet from the internal memory to the external memory depending on the priority information of the data packet. As the received data packets are usually stored in the internal memory, a decision has to be made if the data packet should be kept stored in the internal memory or be transferred to the external memory to be stored in order to allow a quicker data packet receipt. While the data packet is kept in the internal memory if the priority is high and consequently it is to be processed as one of the next, the data packet is transferred to the external memory if the priority is low.

The internal memory has a size to store a number x of data packets to be processed by the processing means, wherein the priority of a data packet is high if the assigned priority information indicates that the data packet is within the next x-1 ones to be processed. The priority of a data packet is low if the assigned priority information indicates that the data packet is not within the next x-1 ones to be processed. This allows an intensive use of the provided internal memory, which allows an optimization of the access of data packets.

According to another example embodiment of the present invention, a method for processing data packets is provided. The data packets which are received from the network are processed, whereby a priority information is assigned to the received data packets. The priority information determines an order of the data packets to be processed. The received data packets are stored in a fast accessible memory, wherein depending on the priority information of the received data packets, the respective data packets are provided in the fast accessible memory for being processed or transferred from a fast accessible memory to a main memory.

The method according to the present invention provides an optimized caching of data packets in a fast accessible memory, e.g. a cache memory or another on-chip memory, which is also called internal memory. While conventional methods of caching data are directed to preload data at addresses following to the actually executed address, the method according to the present invention provides an option to use the priority information determined by the scheduling means not only for determining the order in which the data packets are provided to the processing means but also to determine the data packets that are to be available in the fast accessible memory.

To provide the respective data packets in the fast accessible memory, the respective data packet has to be transferred from the main memory—which can be a memory on a separate chip, also called external memory—to the fast accessible memory if the data packet is stored in the main memory. If the data packet is already stored in the fast accessible memory, the respective data packets should be kept stored in the fast accessible memory and not be transmitted to the main memory. Thus, it is possible that data packets received recently are not transferred to the main memory and then back to the fast accessible memory, but are kept stored in the fast accessible memory, since their priority is high and it is to be processed as one of the next data packets.

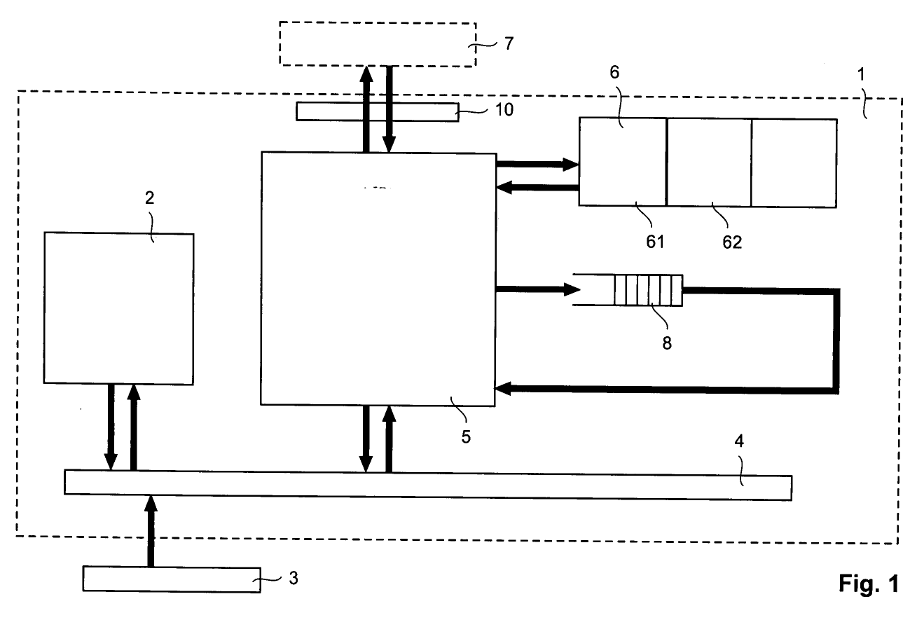

FIG. 1 shows a data packet processing device 1 according to an embodiment of the present invention. The data packet processing device 1 includes a processor 2 to process data packets according to a given program code. The data packets are received from a network 3 via a processor local bus 4. A memory controller 5 is connected to the processor local bus 4 to receive the data packets from the network 3 and to intermediately store the received data packet in an internal memory 6 or in an external memory 7.

The internal memory 6 is a fast accessible memory, a so-called cache memory. Storing the data packet in the internal memory 6 allows a faster receipt of data packets via a (not shown) data interface as the data packets can be stored faster in the internal memory 6 than in the external memory 7. The memory manager 5 is also connected to the external memory 7, which is usually located outside of the data packet processing device. The memory manager 5 and the external memory are connected via an interface 10.

Data packets received from the network 3 are normally stored in the fast accessible internal memory 6 and then transferred to the external memory 7 controlled by the memory manager 5. The received data packets are processed by the processor 2, in an order determined by a scheduler 8. Each of the received packets is examined upon receipt by the scheduler 8 and a priority information is assigned to each of the received data packets. The priority information determines whether a data packet has a high or low priority. The processor 2 is always provided by the data packets with the highest priority of all received data packets and after the respective data packet is completely processed, the data packet with the next highest priority is provided to the processor 2. Before the processor 2 can perform a function to the respective data packets, the data packet has to be loaded into the internal memory 6 from where parts of the data packet or the whole data packet can be accessed faster as it could be if the data packet was stored in the external memory 7. According to the function of the internal memory 6 as a cache, it is desirable that while processing a data packet at least the next data packet to be processed according to the priority is loaded into the internal memory 6.

A scheduler 8 includes a pointer memory to store links (pointers) to the data packet to be processed next. The order of the pointers in the pointer memory is the order of the respective data packets to be processed next. With the receipt of each data packet from the network 3 the order of pointers is actualized, so that after the processing of one data packet the pointer with the address of the next data packet to be processed is provided to the memory manager 5.

The transfer of data packets from the internal memory 6 to the external memory 7 and from the external memory 7 to the internal memory 6 is controlled by the memory manager 5. This handling of the data packets is normally called caching and is performed to give the processor 2 faster access to the data packets when they are stored in the internal memory 6 as the access of data to the external memory 7 is slower. The provision of the external memory 7 is necessary since the number and the size of the received data packets normally exceeds the capacity of the internal memory 6.

To speed up the data excess by the processor 2 the respective data packet, which is actually processed and preferably the data packet which is to be processed next should be stored in the internal memory 6. The decision which data packet should be loaded into the internal memory 6, is made by the memory manager 5 according to the information in the pointer memory of the scheduler 8. The processing order determined by the priority information given by the scheduler 8 is provided to the memory manager 5 which then controls the preloading of the respective data packets with the highest priority into the internal memory 6.

Basically, two options for the further proceedings are usable, depending on where the respective data packet is located. If the respective data packet is stored in the external memory 7, the data packet is transferred to the internal memory 6 controlled by the memory manager 5. If the respective data packet was just received and stored in the internal memory 6, the transfer of the respective data packet to the external memory 7 is not performed. Instead the respective data packet is kept stored in the internal memory 6.

In some embodiments the internal memory 6 is divided up into two sections. A first write section 61 is used to store (buffer) the data packets just received from the network and waiting for the memory manager 5 to transfer the respective data packet from the write section of the internal memory 6 to the external memory 7. As the access to the write section 61 of the internal memory 6 is faster, normally received data packets are first stored in the internal memory. But storing a received data packet directly in the external memory 7 is also possible. The second section, the read section 62, is used to provide the data packets with the highest priority to be processed, i.e. the data packet which is actually processed by the processor 2 and the data packet which are to be processed as the next data packets.

If a data packet is stored in the write section 61 and a high priority is indicated by the pointer memory in the scheduler 8, a transfer of the data package from the write section 61 to the read section 62 can be performed. Also a re-declaration of the write section 61 to a read section 62 could be useful. The write section 61 should be large enough to also handle big data packets. Of course also a plurality of write sections 61 can be provided. The read section 61 is subdivided into one segment per pre-fetched data packet. Normally, it should be sufficient to provide two read segments. If more than one processor 2 is connected to the processor local bus, two read segments 62 per processing entity and two read segments to transmit data packets via the network 3 should be sufficient. If the data packet processing speed of the processor 2 is faster than the preloading of data packets into the internal memory 6 it can be advantageous to arrange more than two read segments 62 per processing entity on the internal memory 6.

In the first of the two read segments 62 the data packet that is currently processed is stored and in the second segment of the two segments the data packet that will be processed next is stored. As soon as the processor 2 finishes working on one data packet and requests the next one, the finished packet in the internal memory 6 is replaced by the next packet in line after the now processed packet. It may be possible that the processed data packet is transferred via the network 3 or is stored in the write section 61 or an additional provided write section 61 of the interval memory 6 to be stored in the external memory 7.

The internal memory 6 has a size to provide enough memory space for the several data packets to be stored. It is also possible that if the size of the data packets is big, only parts of the data packet are preloaded into the internal memory 6. The bigger the capacity of the internal memory 6, the bigger the parts of the data packets that can be pre-fetched. It is therefore not necessary that complete data packets have to be pre-fetched into the internal memory 6. It is also possible that the memory manager 5 first fetches the head of each data packet. If either the processor 2 has its own data cache or if the application code works only once on each part of a packet, then the memory manager 5 can purge any data from the internal memory 6 that has been read by the processor and replaces it with another part of the data packet.

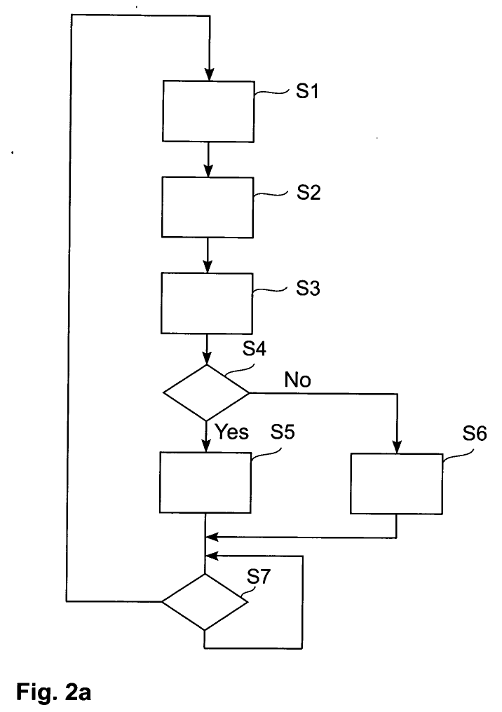

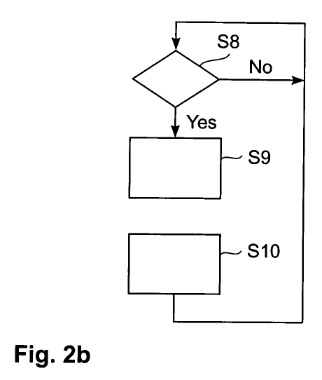

FIGS. 2a and 2b show flow charts illustrating a method of the present invention. They show the handling of a data packet received from a network 3 by the memory manager 5. Referring to FIG. 2a, when a data packet is received from the network 3 (step S1), it is controlled by the memory manager 5 directly stored in the internal memory 6, preferably in the write section 61 of the internal memory 6 (step S2). While transferring the received data packet to the internal memory 6, the scheduler 8 determines the priority of the received data packet and provides priority information assigned to the respective data packet. The priority information of the received data packet and the priority information of the stored data packets are taken into account—if the priority information of the received data packet is not self-explanatory—to determine an order in which the data packets should be processed preferably. The order of the respective data packet indicates if the priority of the data packet is high or low (step S3).

If the priority of the data packet is high (step S4), the received data packet is kept in the internal memory 6 to be processed as one of the next data packets. In the next step S5 the write section 61 of the internal memory 6 is re-declared to a read section or the data packet is copied from the write section 61 to the read section 62 to be provided to the processor 2 to be processed as one of the next data packets. If the write section is re-declared to a read section 62, an available read section 62 has to be defined as a write section so that the internal memory 6 provides enough buffer capacity for incoming data packets. If the priority of the data packet is not high (step S4) in the step S6 the data packet is transferred to the external memory 7 by the memory manager 5.

In step S7, which follows steps S5 and S6, a check is made to determine if a next packet is received which has to be handled by the memory manager 5. If so, the procedure returns to step S1. If no data packet is received it is waited until the next data packet is received.

In addition the process according to FIG. 2b is processed. The processor 2 is requesting the next data packet to be processed. In step S8 it is detected if a read segment 62 of the internal memory is available to be preloaded with a data packet. This can be the case if the processor has fully processed the actual data packet and transferred the processed data packet to the network 3 or the write section 61 of the internal memory 6. If none of the read segments 62 is available, the process returns to step S8, otherwise it proceeds with step S9. The data packet which should be loaded in the available read section 62 is determined by the pointer memory in the scheduler 8 in step S9. It is the data packet with the next highest priority. As the respective data packet is stored in the external memory 7 the data packet is transferred to the internal memory 6, particularly into the read section 62 which is ready to be loaded with an new data packet (step S10). After step 10 the process returns to step S8.

As the smallest possible configuration, one write section 61 and two read sections 62 are sufficient to perform the method according to the present invention. While in one of the read 62 sections the data packet which is currently processed is stored in the other read section 62, the data package which has to be processed next is stored. If the processing of a data packet is faster than the preloading of a data packet in the internal memory 6 it can be useful to provide more than 2 read section 62 per processing entity and network interface, respectively.

In some embodiments of the data packet processing device, context information is assigned to each of the data packets which has to be considered while processing the respective data packet. In this case the internal memory should have a size to store both the context information and the respective data packet or a part of it to speed up the access also to the context information.

In some embodiments more than two read sections 62 per processor 2 are available, which are preloaded with data packets which have to be processed as one of the next. The decision if the priority of data packets is high is then made as follows:

Given that the internal memory has a number x of read sections 62 to store a number of data packets to be processed. The priority of a respective data packet is high if the assigned priority information indicates that the data packet is within the next x-1 ones to be processed, i. e. besides the actually processed data packet, which is stored in one of the read sections 62, a number x-1 of remaining read segments 62 is left to store data packets with a high priority. The priority of a data packet is low if the assigned priority information indicates that the respective data packet is not within the next x-1 ones to be processed.

Variations described for the present invention can be realized in any combination desirable for each particular application. Thus particular limitations, and/or embodiment enhancements described herein, which may have particular advantages to the particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed, is:

1. A data packet processing device for processing data packets received from a network , including:
a processor for processing data packets;
an interface operable for transmitting data packets to and from an external memory;
a scheduler for assigning priority information to received data packets, the priority information determining an order of data packets to be processed;
an internal memory for storing data packets;
a memory manager operable to cause storing data packets in the external memory and to provide data packets in the internal memory for being processed in the processing means; wherein the memory manger provides data packets in the internal memory for being processed by the processor subject to the priority information assigned to the data packets.

2. A data packet processing device according to claim 1, wherein depending on the priority information assigned to a data packet, the memory manager transfers the data packet stored in external memory into internal memory.

3. A data packet processing device according to claim 1, wherein depending on the priority information assigned to a data packet, the memory manager transmits the data packet from the internal memory to the external memory.

4. A data packet processing device according to claim 2, wherein the memory manager means keeps a data packet stored in the internal memory if the priority information assigned to the data packet indicates a high priority, and transmits the data packet to the external memory if the priority information assigned to the data packet indicates a low priority.

5. A data packet processing device according to claim 4, wherein the internal memory has a size to store a number x of data packets to be processed next, wherein the priority of a data packet is high if the assigned priority information indicates that the data packet is within the next x-1 ones to be processed and/or wherein the priority of the data packet is low if the assigned priority information indicates that the data packet is not within the next x-1 ones to be processed.

6. A method comprising processing data packets,
wherein data packets are received from a network;
wherein the data packets are processed;
wherein priority information is assigned to the received data packets, the priority information determining an order of data packets to be processed;
wherein the data packets are stored in a fast accessible memory wherein depending on the priority information assigned to received data packets, the respective data packets are provided in the fast accessible memory for being processed or transferred from the fast accessible memory to a main memory.

7. A method according to claim 6, wherein depending on the priority information assigned to data packets, the provision of the respective data packets in the fast accessible memory for being processed is performed by:
transferring the respective data packet to the fast accessible memory if the data packet is stored in said main memory; or
keeping the respective data packet stored in the fast accessible memory if the data packet is stored in the fast accessible memory.

8. A method according to claim 6, wherein the respective data packet is kept stored in the fast accessible memory if the priority information assigned to the respective data packet indicates a high priority, or is transferred to the main memory to be stored if the priority information assigned to the respective data packet indicates a low priority.

9. A method according to claim 8, wherein the internal memory has a size to store a first number x of data packets,
wherein the priority of a data packet is high if the assigned priority information indicates that the data packet is within the next x-1 ones to be processed, and/or wherein the priority of a data packet is low if the assigned priority information indicates that the data packet is not within the next x-1 ones to be processed.

10. An article of manufacture comprising a computer usable medium having computer readable program code means embodied therein for causing the processing of data packets, the computer readable program code means in said article of manufacture comprising computer readable program code means for causing a computer to effect the steps of claim 6.

11. A program storage device readable by machine, tangibly embodying a program of instructions executable by the machine to perform method steps for processing data packets, said method steps comprising the steps of claim 6.

12. A computer program product comprising a computer usable medium having computer readable program code means embodied therein for causing processing data packets received from a network, the computer readable program code means in said computer program product comprising computer readable program code means for causing a computer to effect the functions of claim 1.

13. A method for processing data packets received from a network, said method comprising:
assigning priority information to received data packet;
employing the priority information to determine a processing order of the received data packets;
storing the received data packets in a fast accessible memory;
providing the received data packets in the fast accessible memory for being processed in accordance with the priority information; and
transferring the received data packets from the fast accessible memory to a main memory in accordance with the priority information.

14. An article of manufacture comprising a computer usable medium having computer readable program code means embodied therein for causing the processing of data packets, the computer readable program code means in said article of manufacture comprising computer readable program code means for causing a computer to effect the steps of claim 13.

15. A program storage device readable by machine, tangibly embodying a program of instructions executable by the machine to perform method steps for processing data packets, said method steps comprising the steps of claim 13.

16. A method for processing a data packet, said method comprising:
receiving the data packet from a network;
storing the data packet in internal memory;
determining a priority of the received data packet and providing priority information assigned to the data packet;
if the priority of the data packet is high, keeping the data packet is kept in the internal memory for processing as one of the next data packets; and
if the priority of the data packet is not high, transferring the data packet to external memory.

17. A method as recited in claim 17, further comprising checking if a next packet is received having a high priority;
if the next packet is received having a high priority, repeating the steps of storing and determining for the next packet; and
if the next data packet is not received, waiting until the next data packet is received and repeating the step of checking.

18. An article of manufacture comprising a computer usable medium having computer readable program code means embodied therein for causing the processing of data packets, the computer readable program code means in said article of manufacture comprising computer readable program code means for causing a computer to effect the steps of claim 16.

19. A program storage device readable by machine, tangibly embodying a program of instructions executable by the machine to perform method steps for processing data packets, said method steps comprising the steps of claim 16.
